(19) United States
(12) Patent Application Publication
(10) Pub. No.: US 2016/0142526 A1
(43) Pub. Date: May 19, 2016

(54) REMOTE MONITORING SYSTEM AND REMOTE MONITORING METHOD

(71) Applicant: proeasy network solutions co., LTD., Hsinchu County (TW)

(72) Inventor: Hsing-Hung Lu, Hsinchu County (TW)

(21) Appl. No.: 14/583,188

(22) Filed: Dec. 25, 2014

(30) Foreign Application Priority Data
Nov. 14, 2014 (TW) 103139599

(51) Int. Cl. H04M 1/725; H04W 8/24; H04W 4/00; H04W 68/00

(52) U.S. Cl. CPC H04M 1/72533; H04W 68/005; H04W 8/245; H04W 4/008

(57) ABSTRACT

The present disclosure provides a remote monitoring system and a remote monitoring method. The remote monitoring system includes a mobile device, a sensor and a controller. The mobile device receives an incoming-call signal from a remote mobile device. The sensor is disposed on the mobile device and generates a sensing signal according to a reaction of the mobile device after receiving the incoming-call signal. The controller is coupled to the mobile device and the sensor. The controller receives the sensing signal and charges the mobile device after receiving the sensing signal.

### CROSS-REFERENCE TO RELATED APPLICATION

This application claims the priority benefit of Taiwan application serial no. 103139599, filed on Nov. 14, 2014. The entirety of the above-mentioned patent application is hereby incorporated by reference herein and made a part of this specification.

### BACKGROUND

1. Technical Field

The disclosure relates to a remote monitoring system and a remote monitoring method, and particularly relates to a remote monitoring system having a long time standby function and a remote monitoring method.

2. Related Art

In recent years, along with booming development of computer technology, a plenty of automation equipment, for example, washing machine, dishwasher and sweeping robot, etc., are applied in people's daily life. Moreover, due to a change of family demographic structures and a change of social work styles, manpower devoted to family general affairs is gradually replaced by machines. Therefore, integration solutions capable of integrally managing and controlling various home appliances or equipment such as lightings, television, security system, air conditioner, audio-visual sound system, etc. are continually developed, and terms such as smart home, digit home, electronic home, home automation, etc. are appeared one after another.

Home automation control system is to use automated equipment and computer software technology and program application in collaboration with home appliances such as television, electric cooker, air conditioner, refrigerator, gas switch, alarm system, security system, surveillance system, etc., to improve family comfort and home security. The home automation control system generally includes a control system and a control host, and a user gives control commands through the control system to drive various equipment through the control host. Besides, through various wireless communication transmission techniques such as a general packet radio service (GPRS), a wireless fidelity (WiFi) system, a worldwide interoperability for microwave access (WiMAX) system, a third generation (3G) or a long term evolution (LTE) technique, etc., even in case of a business trip, vacation, travelling, etc., the user can still access the Internet through a network connection function of a mobile phone, a notebook, etc., to control various equipment in home or activate a security system, or conduct surveillance on home status, by which higher flexibility and convenience are achieved.

Although the home automation control system brings convenience to life, it consumes considerable power in case of all-day operation. Therefore, how to achieve a maximum standby time of the home automation devices under a premise of saving power consumption as far as possible is an important issue to be studied by related researchers.

### SUMMARY

Accordingly, the disclosure is directed to a remote monitoring system and a remote monitoring method, by which an image transmission request sent by a remote mobile device to a home mobile device is detected, and the home mobile device is dynamically charged only when the home mobile device transmits an image to the remote mobile device, so as to achieve a long-time standby function of the home mobile device.

An exemplary embodiment of the disclosure provides a remote monitoring system including a mobile device, a sensor and a controller. The mobile device receives an incoming-call signal from a remote mobile device. The sensor is disposed on the mobile device and generates a sensing signal according to a reaction of the mobile device after receiving the incoming-call signal. The controller is coupled to the mobile device and the sensor. The controller receives the sensing signal and switches a power switch, such that a power supply unit charges the mobile device in response to the sensing signal.

In an exemplary embodiment of the disclosure, the mobile device receives the incoming-call signal from the remote mobile device through a mobile communication network.

In an exemplary embodiment of the disclosure, a camera unit of the mobile device captures an image, and transmits the image to the remote mobile device.

In an exemplary embodiment of the disclosure, the mobile device activates an application, and the application controls the camera unit to capture the image and transmit the image to the remote mobile device.

In an exemplary embodiment of the disclosure, the reaction is a vibration generated by the mobile device or a light generated by a screen of the mobile device.

In an exemplary embodiment of the disclosure, the power switch is coupled to the mobile device through a universal serial bus connector, so as to implement wired charging to the mobile device.

In an exemplary embodiment of the disclosure, the power switch is coupled to a wireless charging device located at a side of the mobile device, so as to implement wireless charging to the mobile device.

In an exemplary embodiment of the disclosure, the controller receives the sensing signal through a short-distance communication standard.

In an exemplary embodiment of the disclosure, the controller receives the sensing signal through a universal asynchronous receiver/transmitter.

An exemplary embodiment of the disclosure provides a remote monitoring method, which includes following steps. An incoming-call signal is received from a remote mobile device by using a mobile device. A sensing signal is generated according to a reaction of the mobile device after receiving the incoming-call signal. The sensing signal is received by using a controller, and a power switch is switched, such that a power supply unit charges the mobile device in response to the sensing signal.

In an exemplary embodiment of the disclosure, the mobile device receives the incoming-call signal from the remote mobile device through a mobile communication network.

In an exemplary embodiment of the disclosure, the remote monitoring method further includes capturing an image by using a camera unit of the mobile device after the mobile device receives the incoming-call signal, and transmitting the image to the remote mobile device.

In an exemplary embodiment of the disclosure, the remote monitoring method further includes activating an application by using the mobile device after the mobile device receives the incoming-call signal, wherein the application controls the camera unit to capture the image and transmit the image to the remote mobile device.

In an exemplary embodiment of the disclosure, the reaction is a vibration generated by the mobile device or a light generated by a screen of the mobile device.

In an exemplary embodiment of the disclosure, the power switch is coupled to the mobile device through a universal serial bus connector, so as to implement wired charging to the mobile device.

In an exemplary embodiment of the disclosure, the power switch is coupled to a wireless charging device located at a side of the mobile device, so as to implement wireless charging to the mobile device.

In an exemplary embodiment of the disclosure, the controller receives the sensing signal through a short-distance communication standard.

In an exemplary embodiment of the disclosure, the controller receives the sensing signal through a universal asynchronous receiver/transmitter.

According to the above descriptions, in the remote monitoring system of the disclosure, when the user makes an incoming-call to the mobile device in home from a remote end in order to obtain a real-time monitoring image, the sensor senses a vibration or light generated by the mobile device after receiving the incoming-call, and the controller starts to charge the mobile device. Based on such dynamic charging mechanism, the mobile device is charged only when the mobile device captures images, such that the remote monitoring system of the disclosure has a long-time standby time even if the remote monitoring system is not connected to a household outlet or during power outage caused by accident.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a remote monitoring system according to an exemplary embodiment of the disclosure.

FIG. 2 is a block diagram of a remote monitoring system according to an embodiment of the disclosure.

FIG. 3 is a flowchart illustrating a remote monitoring method according to an exemplary embodiment of the disclosure.

FIG. 4 is a flowchart illustrating a remote monitoring method according to another exemplary embodiment of the disclosure.

### DETAILED DESCRIPTION OF DISCLOSED EMBODIMENTS

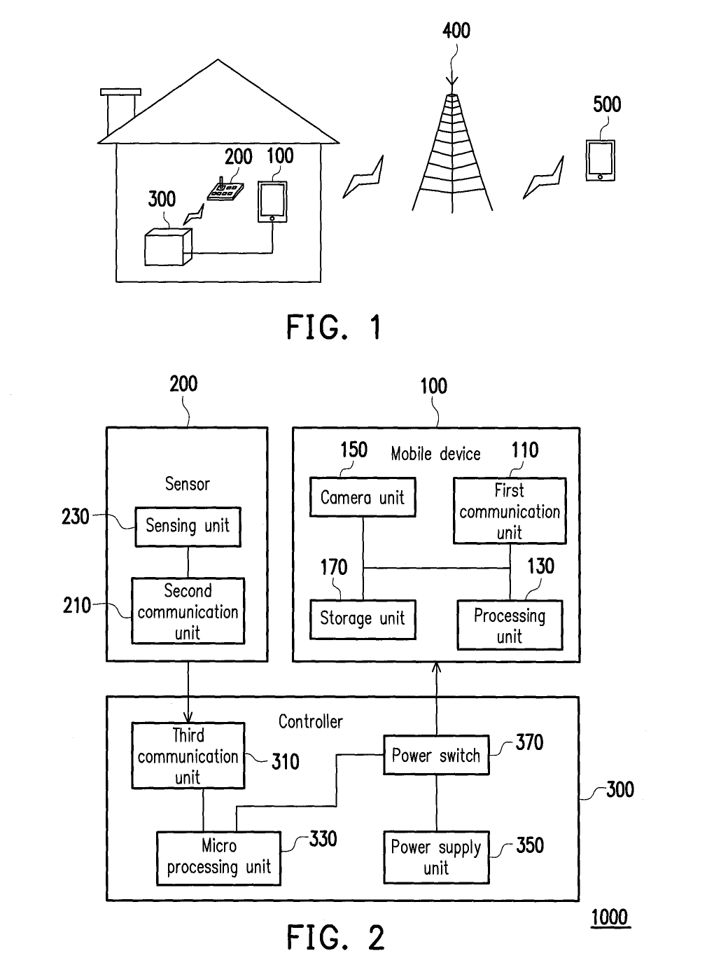

FIG. 1 is a schematic diagram of a remote monitoring system according to an exemplary embodiment of the disclosure.

Referring to FIG. 1, the remote monitoring system 1000 of the disclosure includes a mobile device 100 disposed in a home environment, a sensor 200 and a controller 300.

The mobile device 100 includes a subscriber identity module card (SIM card). The mobile device 100 can be a cell phone, a personal digital assistant (PDA) phone or a smart phone, etc., which is not limited by the disclosure.

The mobile device 100 can communicate with a remote mobile device 500 through a mobile communication network 400. The mobile communication network 400 can be a telecommunication service provided by a telecom service provider, for example, one of a global system for mobile communication (GSM) system, a personal handy-phone system (PHS), a code division multiple access (CDMA) system, a wireless fidelity (WiFi) system, a worldwide interoperability for microwave access (WiMAX) system, a third generation (3G) wireless communication technique, a long term evolution (LTE) technique, etc., or a combination thereof, which is not limited by the disclosure.

In an exemplary embodiment of the disclosure, the user can monitor a status of home by using the carried remote mobile device 500 when going out. In detail, the user can dial the mobile device 100 in home by using the remote mobile device 500, and after the mobile device 100 confirms that a source number of the phone call belongs to the remote mobile device 500, the mobile device 100 activates an application (APP) having an image capturing function, for example, SKYPE, and a camera of the mobile device 100 starts to capture an image, and transmits the captured image to the remote mobile device 500 for the user through the mobile communication network 400, such that the user can easily obtain a real-time monitoring image of home through the remote mobile device 500.

After the mobile device 100 receives a signal from the remote mobile device 500 and confirms an identity of the remote mobile device 500, the mobile device 100 generates a vibration or wakes up a screen from a sleep mode, and starts to capture an image and provides the same to the user. Since it is a power-consuming operation to user the mobile device 100 to capture image, when the sensor 200 senses the vibration of the mobile device 100 or a light generated by the screen waken up by the mobile device 100, the sensor 200 transmits a sensing signal to the controller 300. After receiving the sensing signal, the controller 300 determines that the mobile device 100 starts to capture image and consumes a large mount of power, and switches a power switch to start charging the mobile device 100.

It should be noticed that the controller 300 can be directly connected to a household outlet or a large-capacity mobile power supply, such that the mobile device 100 can operate for a long time, and has a long-time standby function. The sensor 200 can be set close to the mobile device 100 and senses a vibration of the mobile device 100. Alternatively, the sensor 200 can be disposed in front of a light-emitting direction of the screen of the mobile device 100, and senses the light emitted by the screen.

FIG. 2 is a block diagram of a remote monitoring system according to an embodiment of the disclosure.

Referring to FIG. 2, the mobile device 100 of the present exemplary embodiment of the disclosure includes a first communication unit 110, a processing unit 130, a camera unit 150 and a storage unit 170. The sensor 200 includes a sensing unit 230 and a second communication unit 210. The controller 300 includes a third communication unit 310, a micro processing unit 330, a power supply unit 350 and a power switch 370.

The first communication unit 110 receives a signal from the remote mobile device 500 through the mobile communication network 400. After receiving the signal, the processing unit 130 determines whether a source of the signal is a predetermined telephone number. When the processing unit 130 determines that the source of the signal is the predetermined telephone number, the processing unit 130 activates an application (for example, SKYPE) stored in the storage unit 170, and sends an image capturing command to the application. Now, the application starts to capture an image by using the camera unit 150, and transmits the captured image to the remote mobile device 500 through the first communication unit 110, such that the user can easily obtain a real-time monitoring image of home through the remote mobile device 500.

It should be noticed that the first communication unit 110 can be a communication chip supporting one of a global system for mobile communication (GSM) system, a personal handy-phone system (PHS), a code division multiple access (CDMA) system, a wireless fidelity (WiFi) system, a worldwide interoperability for microwave access (WiMAX) system, a third generation (3G) wireless communication technique, a long term evolution (LTE) technique, etc., or a combination thereof. The processing unit 130 can be a micro processor. The storage unit 170 can be a random access memory (RAM), a read-only memory (ROM), a flash memory, a compact flash (CF) memory card, a secure digital (SD) memory card, a micro SD memory card, a memory stick (MS), etc., though the disclosure is not limited thereto.

After the mobile device 100 receives the signal from the remote mobile device 500 and confirms that the source of the signal is the predetermined telephone number, the mobile device 100 generates a vibration, and activates the screen thereof to prepare capturing the image by using the camera unit 150. The sensor 200 can be a vibration sensor or a light sensor.

The sensing unit 230 of the sensor 200 senses the vibration or the light of the mobile device 100, and generates a corresponding vibration sensing signal or a light sensing signal. The sensing signal can be transmitted to the controller 300 through the second communication unit 210 and the third communication unit 310. After the controller 300 receives the sensing signal, the micro processing unit 330 switches the power switch 370 that is connected to the power supply unit 350 according to the sensing signal to start charging the mobile device 100. In the aforementioned exemplary embodiment, although the power supply unit 350 and the power switch 370 are configured in the controller 300, the disclosure is not limited thereto. The power supply unit 350 and the power switch 370 can also be independently configured out of the controller 300, and are coupled to the controller 300.

It should be noticed that the micro processing unit 330 can be a central processing unit (CPU), a microprocessor, a digital signal processor (DSP), a programmable controller, an application specific integrated circuits (ASIC), a programmable logic device (PLD) or other similar devices. The second communication unit 210 and the third communication unit 310 can be communication chips supporting a short-distance communication standard such as bluetooth, ANT wireless transmission or Zigbee, etc. In the above description, although the sensor 200 and the controller 300 can communication with each other through wireless transmission, the disclosure is not limited thereto. The sensor 200 and the controller 300 can also communicate with each other by using a wired universal asynchronous receiver/transmitter (UART), for example, by using a RS232 transmission line.

In the present exemplary embodiment of the disclosure, the power supply unit 350 can be connected to a household outlet or a mobile power supply, and can charge the mobile device 100 through a mini universal serial bus (mini USB) or a micro universal serial bus (micro USB). In detail, taking a USB 2.0 as an example, the power supply unit 350 can enable three pins (i.e. a live wire pin, a grounding pin and an identification pin) other than data pins (Data+×pin and Data− pin) in five pins of the mini USB or the micro USB though the power switch 370, so as to charge the mobile device 100.

In the aforementioned description, although the power switch 370 can implement wired charging to the mobile device 100 through the mini USB or the micro USB, the disclosure is not limited thereto. The power switch 370 can also be connected to a wireless charging device located at a side of the mobile device 100, and perform wireless charging to the mobile device 100 through the wireless charging device. It should be noticed that the wireless charging device can be a wireless charger complied with a Qi wireless charging standard of a wireless power consortium (WPC), though the disclosure is not limited thereto.

FIG. 3 is a flowchart illustrating a remote monitoring method according to an exemplary embodiment of the disclosure.

Referring to FIG. 3, in step S301, the mobile device 100 in home receives an incoming-call signal from the remote mobile device 500 through the mobile communication network 400, and after the mobile device 100 receives the incoming-call signal from the remote mobile device 500, the mobile device 100 generates a vibration and activates a screen thereof.

Then, in step S303, a vibration sensor contacting the mobile device 100 or a light sensor set in front of the screen of the mobile sensor 100 senses the vibration generated by the mobile device 100 or the light generated by the activated screen, and transmits a vibration sensing signal or a light sensing signal to the controller 300. Finally, in step S305, the controller 300 receives the vibration sensing signal or the light sensing signal and switches the power switch 370 to perform wired charging or wireless charging to the mobile device 100 through the power supply unit 350 in response to the sensing signal.

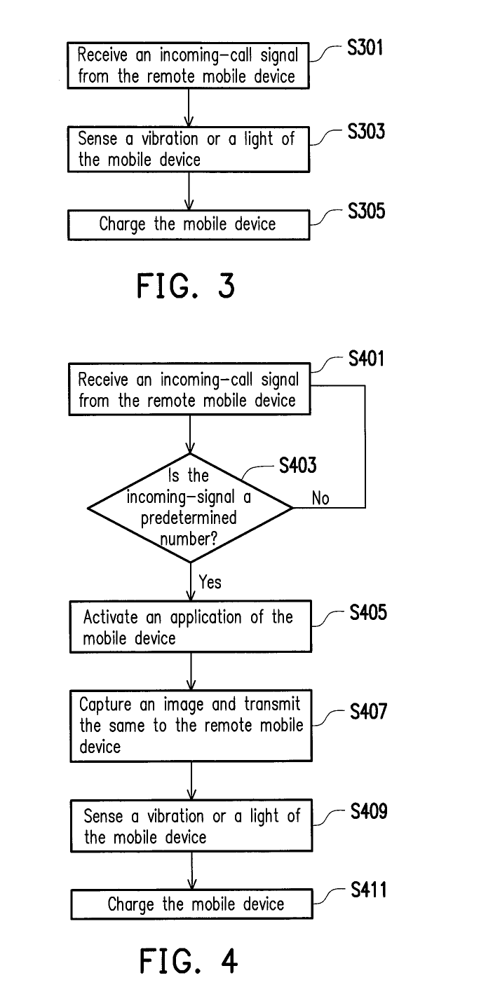

FIG. 4 is a flowchart illustrating a remote monitoring method according to another exemplary embodiment of the disclosure.

Referring to FIG. 4, first, in step S401, the mobile device 100 in home receives an incoming-call signal from the remote mobile device 500 through the mobile communication network 400, and after the mobile device 100 receives the incoming-call signal from the remote mobile device 500, the mobile device 100 generates a vibration and activates the screen thereof.

Then, in step S403, it is determined whether the incoming-call of the remote mobile device 500 is a predetermined number set in the mobile device 100. If the incoming-call signal of the remote mobile device 500 is the predetermined number set in the mobile device 100, the user's ID is confirmed, and in step S405, the mobile device 100 activates an application stored in the storage unit 170. Then, in step S407, the application captures an image by using the camera of the mobile device 100 and transmits the image to the remote mobile device 500 through the mobile communication network 400, such that the user can obtain a real-time monitoring image of home.

Then, in step S409, a vibration sensor contacting the mobile device 100 or a light sensor set in front of the screen of the mobile sensor 100 senses the vibration generated by the mobile device 100 or the light generated by the activated screen, and transmits a vibration sensing signal or a light sensing signal to the controller 300. Finally, in step S411, the controller 300 receives the vibration sensing signal or the light sensing signal and switches the power switch 370 to perform wired charging or wireless charging to the mobile device 100 through the power supply unit 350.

In summary, in the remote monitoring system of the disclosure, when the user makes an incoming-call to the mobile device in home from the remote mobile device in order to obtain a real-time monitoring image, it is determined whether the phone number of the remote mobile device is the predetermined number set in the mobile device in home, and after confirming the user's ID, the image is captured and transmitted to the remote mobile device. Since the mobile device consumes a large amount of power when capturing images, when the sensor senses the vibration or light generated by the mobile device after receiving the incoming-call, the controller starts to charge the mobile device. Based on such dynamic charging mechanism, the mobile device is charged only when the mobile device captures images, and in the rest of time, since the mobile device is maintained to a standby state, it is unnecessary to charge the mobile device. In this way, the remote monitoring system of the disclosure has a long-time standby time even if the remote monitoring system is not connected to the household outlet or during power outage caused by accident.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A remote monitoring system, comprising:
a mobile device, wherein the mobile device receives an incoming-call signal from a remote mobile device;
a sensor disposed on the mobile device, wherein the sensor generates a sensing signal according to a reaction of the mobile device after receiving the incoming-call signal;
a power supply unit coupled to a power switch; and
a controller coupled to the mobile device, wherein the controller receives the sensing signal and switches the power switch to charge the mobile device through the power supply unit in response to the sensing signal.

2. The remote monitoring system as claimed in claim 1, wherein the mobile device receives the incoming-call signal from the remote mobile device through a mobile communication network.

3. The remote monitoring system as claimed in claim 1, wherein a camera unit of the mobile device captures an image, and transmits the image to the remote mobile device.

4. The remote monitoring system as claimed in claim 3, wherein the mobile device activates an application, and the application controls the camera unit to capture the image and transmit the image to the remote mobile device.

5. The remote monitoring system as claimed in claim 1, wherein the reaction is a vibration generated by the mobile device or a light generated by a screen of the mobile device.

6. The remote monitoring system as claimed in claim 1, wherein the power switch is coupled to the mobile device through a universal serial bus connector to implement wired charging to the mobile device.

7. The remote monitoring system as claimed in claim 1, wherein the power switch is coupled to a wireless charging device located at a side of the mobile device to implement wireless charging to the mobile device.

8. The remote monitoring system as claimed in claim 1, wherein the controller receives the sensing signal through a short-distance communication standard.

9. The remote monitoring system as claimed in claim 1, wherein the controller receives the sensing signal through a universal asynchronous receiver/transmitter.

10. A remote monitoring method, comprising:
receiving an incoming-call signal from a remote mobile device by using a mobile device;
generating a sensing signal according to a reaction of the mobile device after receiving the incoming-call signal; and
receiving the sensing signal by using a controller, and switching a power switch to charge the mobile device in response to the sensing signal.

11. The remote monitoring method as claimed in claim 10, wherein the mobile device receives the incoming-call signal from the remote mobile device through a mobile communication network.

12. The remote monitoring method as claimed in claim 10, further comprising:
capturing an image by using a camera unit of the mobile device after the mobile device receives the incoming-call signal, and transmitting the image to the remote mobile device.

13. The remote monitoring method as claimed in claim 12, further comprising:
activating an application by using the mobile device after the mobile device receives the incoming-call signal, wherein the application controls the camera unit to capture the image and transmit the image to the remote mobile device.

14. The remote monitoring method as claimed in claim 10, wherein the reaction is a vibration generated by the mobile device or a light generated by a screen of the mobile device.

15. The remote monitoring method as claimed in claim 10, wherein the power switch is coupled to the mobile device through a universal serial bus connector to implement wired charging to the mobile device.

16. The remote monitoring method as claimed in claim 10, wherein the power switch is coupled to a wireless charging device located at a side of the mobile device to implement wireless charging to the mobile device.

17. The remote monitoring method as claimed in claim 10, wherein the controller receives the sensing signal through a short-distance communication standard.

18. The remote monitoring method as claimed in claim 10, wherein the controller receives the sensing signal through a universal asynchronous receiver/transmitter.
